(19) United States
(12) Patent Application Publication
(10) Pub. No.: US 2011/0240244 A1
(43) Pub. Date: Oct. 6, 2011

(54) EXOTHERMIC WELDING MOLD WITH INTEGRAL COVER

(76) Inventors: Timothy P. Sepelak, Willoughby, OH (US); Keith R. Anthony, Burton, OH (US)

(21) Appl. No.: 13/080,067

(22) Filed: Apr. 5, 2011

Related U.S. Application Data
(60) Provisional application No. 61/320,794, filed on Apr. 5, 2010.

(51) Int. Cl. B23K 23/00; B22D 41/00

(52) U.S. Cl. 164/54; 249/106; 249/197

(57) ABSTRACT

An exothermal weld mold includes a mold section with an integral cover portion, made as part of a single piece of material with the rest of the mold section. The mold section may be a mold half of a vertically split mold, or may constitute most of a half of the mold. The cover portion may be part of an integral cover that covers substantially all of a reaction chamber or crucible of the mold. The cover may have one or more vent holes, in the top and/or side of the mold. The cover may have a baffled passage for expansion of gases produced by reaction of the weld material, before the gases are expelled from the mold at an opening in the top or side of the mold. The passage may be a serpentine passage. A filter may be placed in the passage.

This application claims priority from U.S. Provisional Application No. 61/320,744, filed Apr. 5, 2010, the entire disclosure of which is incorporated herein by reference.

### TECHNICAL FIELD OF THE INVENTION

The invention is in the general field of exothermic welding.

### DESCRIPTION OF THE RELATED ART

Exothermic welding is a method that utilizes a self-propagating exothermic reaction that produces and delivers molten metal for permanently joining (welding) various metallic conductors in any of a myriad of combinations. Examples of self propagating exothermic reactions are found in the CADWELD® process and the Thermit® process. CADWELD is a trademark of ERICO International Corporation, Solon, Ohio, U.S.A., and Thermit is a trademark of Th. Goldschmidt AG, Essex, Germany. Exothermic mixtures are basically a combination of a reductant metal and usually a transition metal oxide. An example is aluminum and copper oxide, which upon ignition supplies enough heat to propagate and sustain a reaction within the mixture. It is usually the molten metal product or the heat of this reaction, which is then used to produce a desired result. The CADWELD process produces, for example, a mixture of molten copper and aluminum oxide or slag. The molten copper has a higher density than the slag and is usually directed by a mold to join or weld copper to copper, copper to steel, or steel to steel. The aluminum oxide slag is removed from the weld or joint and discarded. Another common mixture is iron oxide and aluminum. Where only the heat of the reaction is used, the heat may be used to fuse brazing material, for example.

The most common way to contain the exothermic reaction, and to produce the weld or joint, involves the use of split graphite molds (see prior art example in FIG. 1, showing a cutaway of a horizontally split mold). The conductors or items to be joined (e.g., bars) 22 and 24 are thoroughly cleaned and then placed in the appropriate location to project into a weld chamber 26 in a graphite mold 12 of a welding apparatus 10. The mold is then securely closed and locked usually with a toggle or other clamp. The molds typically include a crucible or reaction chamber 30 above the weld chamber, connected to the weld chamber by a tap hole 32. An appropriate amount of exothermic material 36 is placed in the mold crucible, either in a sealed container or poured loose onto a metal disk 34 placed in the bottom of the crucible. The mold cover 20 is then closed and the reaction initiated either through the use of a flint igniter with starting material 40 or an electrical igniter. When the exothermic material is ignited, the molten metal phase separates from the slag and melts through the metal disk or container. The molten metal then is directed via the tap hole to the weld chamber and the conductors to be joined. Once the metal has solidified, the mold body sections 14 and 16 are opened and the slag is separated from the weld connection. The mold may then be cleaned and readied for reuse for the next connection.

### SUMMARY OF THE INVENTION

Embodiments described herein include exothermic welding molds that incorporate an integral cover, the benefits of which are increased exothermic welding reaction containment and gas-venting control, while also improving mold quality and durability in use, simplifying mold manufacturing processes, and reducing costs to produce molds. Prior problems with exothermic welding molds include occasionally decreased reaction containment and gas-venting control, loose and/or broken mold cover hinges, broken molds at hinge attachment points, and potential to not use the cover at all.

Embodiments described herein include a new and novel configuration for the split graphite molds that incorporates a gas-venting cover integrally into the same continuous graphite parts that form the weld chamber (cavity) and crucible. The purpose is to help contain the exothermic reaction and control the venting of hot gases from the mold. Disclosed embodiments accomplish these functions more effectively than standard molds now in use.

According to one aspect of the invention, an exothermic welding reaction mold cover is integral to the mold itself (versus being a separate piece, or a separately attached piece).

According to another aspect of the invention, an integral mold cover is locked closed along with the mold itself by the standard mold handle clamps now in use.

According to yet another aspect of the invention, an integral mold cover is machined in the same operation as the mold itself from a continuous block of graphite (or other suitable material).

According to still another aspect of the invention, an integral mold cover eliminates the gap between the mold top (crucible section) and standard mold covers now in use. This feature increases exothermic welding reaction containment and gas-venting control.

According to a further aspect of the invention, an integral mold cover allows for manufacturing of more intricate and effective baffles for controlled venting of reaction-gases. This feature also increases containment of exothermic welding reactions.

According to a still further aspect of the invention, an integral mold cover eliminates the mold cover hinge (from vertically split molds), which is prone to quality problems during use. This feature also eliminates a manual production assembly step, reducing production costs.

According to another aspect of the invention, an exothermal weld mold includes: a mold section having a crucible portion that defines part of a reaction crucible for receiving an exothermic weld metal material. The mold section includes an integral-formed cover portion, formed with the rest of the mold section as a single piece of material, that covers the reaction crucible at least in part.

According to yet another aspect of the invention, an exothermal weld mold includes: a mold section having a crucible portion that defines part of a reaction crucible for receiving an exothermic weld metal material. The mold section includes an integral-formed cover portion, formed with the rest of the mold section as a single piece of material. The cover portion includes a passage therethrough to an opening for expelling gasses from a reaction crucible portion of the mold section.

According to still another aspect of the invention, a method of exothermic welding includes: reacting weld material in a reaction crucible of a mold to produce molten weld metal; and venting gases from the reacting weld material through an opening in the mold, wherein the opening is in a cover portion of a mold section of the mold that is formed as part of a single piece with a crucible portion of the mold that at least in part defines the reaction crucible.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The accompanying drawings, which are not necessarily to scale, show various aspects of certain exemplary embodiments of the invention.

FIG. 1 is a cutaway view of a prior art welding apparatus that includes a horizontally split mold.

FIG. 2 is an oblique view of a mold section with an integrally-formed cover, in accordance with an embodiment.

FIG. 3 is an oblique view of a mold section with an integrally-formed cover, in accordance with another embodiment.

FIG. 4 is a sectional view of a prior art weld material self-contained crucible assembly.

FIG. 5 is an oblique view of a mold, in accordance with a third embodiment.

FIG. 6 is an oblique view of a mold section of the mold of FIG. 5.

FIG. 7 is an oblique view of a mold section, in accordance with a fourth embodiment.

FIG. 8 is an oblique view of a mold section, in accordance with a fifth embodiment.

FIG. 9 is an oblique view of a mold, in accordance with a sixth embodiment.

FIG. 10 is an oblique view of a mold section of the mold of FIG. 9.

FIG. 11 is an oblique view of a mold section, in accordance with a seventh embodiment.

FIG. 12 is an oblique view of a mold section, in accordance with an eighth embodiment.

FIG. 13 is an oblique view of a mold, in accordance with a ninth embodiment.

FIG. 14 is an oblique view of two of the mold sections of the mold of FIG. 13.

FIG. 15 is an oblique view of a mold, in accordance with a tenth embodiment.

FIG. 16 is an oblique view of two of the mold sections of the mold of FIG. 15.

FIG. 17 is an oblique view of a mold, in accordance with an eleventh embodiment.

FIG. 18 is an oblique view of a mold section of the mold of FIG. 17.

FIG. 19 is an oblique view of a mold section, in accordance with a twelfth embodiment.

FIG. 20 is an oblique view of the mold section of FIG. 19, with a filter installed in the mold section.

FIG. 21 is an oblique view of a mold section with a filter, in accordance with a thirteenth embodiment.

FIG. 22 is an oblique view of a mold, in accordance with a fourteenth embodiment.

FIG. 23 is an oblique view of a mold section of the mold of FIG. 22.

### DETAILED DESCRIPTION

An exothermal weld mold includes a mold section with an integral cover portion, made as part of a single piece of material with the rest of the mold section. The mold section may be a mold half of a vertically split mold, or may constitute most of a half of the mold. The cover portion may be part of an integral cover that covers substantially all of a reaction chamber or crucible of the mold. The cover may have one or more vent holes, in the top and/or side of the mold. The cover may have a baffled passage for expansion of gases produced by reaction of the weld material, before the gases are expelled from the mold at an opening in the top or side of the mold. The passage may be a serpentine passage. A filter may be placed in the passage. The use of the integral cover portion improves mold life and performance, and reduces manufacturing effort and costs.

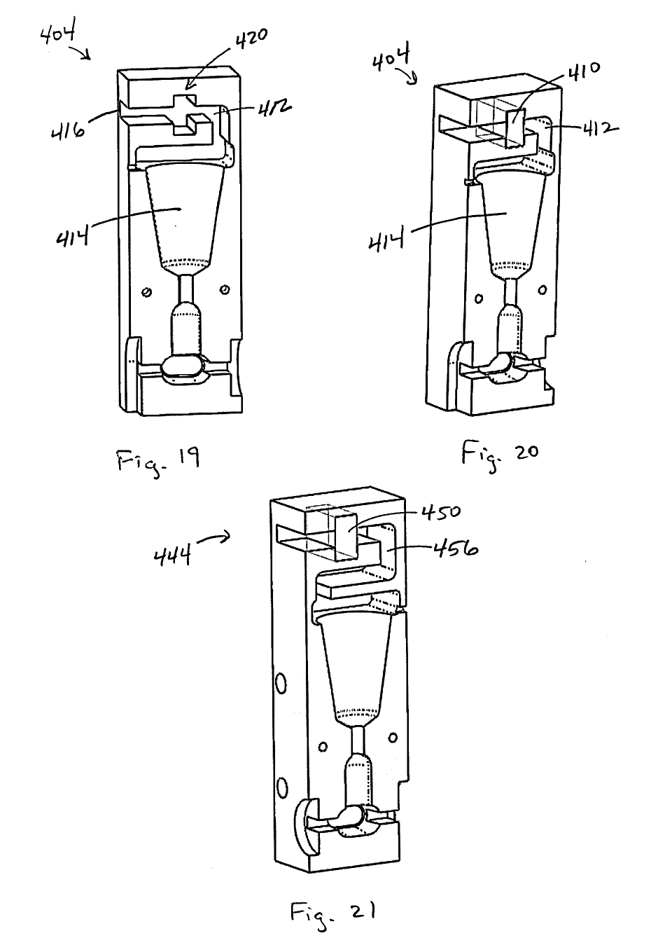

FIGS. 2 and 3 illustrate two examples of one-half of a vertically split graphite mold (a “mold section”) used for exothermic welding. The graphite mold consists of three primary sections, a weld chamber or cavity 5, a reaction crucible 2 and a baffled gas-venting cover 1. All sections of the mold are integrally incorporated into the same mold part.

In the present example, a self-contained welding material container (e.g., CADWELD PLUS) is situated into the mold crucible 2 such that the igniter extends through the igniter opening 8. Further details regarding the CADWELD PLUS system may be found at www.erico.com, the website of ERICO International Corporation, of Solon, Ohio USA, the seller of the CADWELD PLUS system, and in U.S. Pat. No. 6,835,910, the figures and description of which are incorporated herein by reference. Referring to FIG. 4, the CADWELD PLUS system utilizes a self-contained crucible assembly 50 for forming a weld between a pair of metal articles. The crucible assembly 50 includes a container 52 with side walls 54 and a fusible bottom 56; an optional refractory material liner 60; an exothermic weld material 64 within the container 52; an igniter 66 with a first end 68 partially within or close to the weld material 64, and a second end 70 protruding the container 52; and a cover 74, such as a foil, sealing the weld material within the container 52. The welding material container 52 is supported in place by a suitable profile of the crucible 2. Conductors or items to be joined are thoroughly cleaned and then placed in the conductor opening(s) 6 to project into a weld chamber 5 in the graphite mold. The mold is then securely closed and locked usually with a toggle or other clamp, and the reaction initiated by the electrical igniter. When the exothermic material is ignited the self-propagating reaction proceeds quickly, hot gases vent through the integral baffle cover 1, and the liquefied molten metal phase separates from the slag and melts through the bottom of the welding material container. The molten metal then is directed via the tap hole 3 to the weld chamber 5 and the conductors to be joined, while the slag remains in the slag cavity 4. Once the metal has solidified, the mold body sections are opened and the slag is separated from the weld connection. The mold may then be cleaned and readied for reuse for the next connection.

FIGS. 2 and 3 show the following parts for the illustrated mold sections: an integrated baffled vent (cover) 1, a reaction crucible 2, a tap 3, a slag cavity 4, a weld chamber (weld cavity) 5, conductor opening(s) 6, alignment dowel holes 7 for receiving suitable dowels for alignment of mold sections, and an igniter slot 8. Molds may be formed from a pair of identical or complementary mold sections. Two mold sections may form a complete mold, with the mold sections having a vertical split between them, such as with the illustrated mold sections. Alternatively there may be three or more mold sections including both at least one vertical split and at least one horizontal split.

The concept for molds with an integrated baffle cover offers advantages in exothermic welding reaction containment and gas-venting control, manufacturing and cost savings to produce, product quality and durability in use, and ease of use. Premium exothermic welding mold products (e.g., the CADWELD EXOLON molds sold by ERICO International Corporation of Solon, Ohio USA) do exist that may offer increased reaction containment and gas-venting control over current standard molds, but such premium products require additional parts, are more costly, and are more complex to use. The mold sections described above achieve similar if not equivalent reaction containment and gas-venting control to premium products, but accomplish this in what would be considered “standard” mold product.

Molds with integral covers for performing exothermic welding increase reaction containment and gas-venting control by allowing for incorporation of more intricate and effective baffles and by eliminating the gap that exists between the mold top (crucible section) and separate mold cover typically in use. This described gap presents an undesired path for both hot gases and molten metal to escape during exothermic reactions, instead of venting strictly through the cover as intended. Present cover baffles are limited by reasonable manufacturing capabilities and/or cost to produce. Another problem with a separate mold cover is the potential for a user to not close the cover at all, providing almost no reaction containment. However, integral mold covers are locked closed along with the mating mold parts themselves by the standard mold handle-clamps in use. This ensures a tight seal between the mold cover halves is maintained. Further, molds incorporating the integral cover allow previously unreachable machining access to create better cover baffling schemes.

The integral mold cover described above eliminates the mold cover hinge (from vertically split molds), which is prone to quality problems during use and assembly. The hinges used with present mold covers can decrease the life of graphite molds by breaking molds at screw attachment points, and further the hinges can also cause increasing gaps between mold crucibles and covers as described in the paragraph above as the hinges deteriorate in function upon experiencing the thermal cycles of exothermic welding. Also by eliminating the hinge, the integrated mold cover also eliminates a manual production assembly step, reducing production costs.

Additionally, the integral mold cover is machined in the same operation as the mold itself from a continuous block of graphite (or other suitable material). This actually simplifies and reduces total mold machining requirements, reducing production cost.

The integral mold cover described above can be applied to both vertically split and horizontally split molds. Vertically split molds maximize the benefits described above, whereas horizontally split molds may incorporate a fully integrated baffle cover on one mold half while the other mold half uses a hinge for the crucible/cover section and/or lock closed via toggle clamps or press-fit latches as used in various known molds. Horizontally split molds may be converted to vertically split molds, where practical, to maximize the benefits of the integral baffle cover. Other methods for integrating this cover into horizontally split molds may be utilized.

The integral mold cover concept can be applied to all molds utilized for exothermic welding regardless of the thousands of configurations of weld cavities employed for any combinations of conductors to be welded, not just those depicted pictorially or schematically herein. Similarly, the baffle in the cover section of the mold can take on many variations, not just those depicted pictorially or schematically herein.

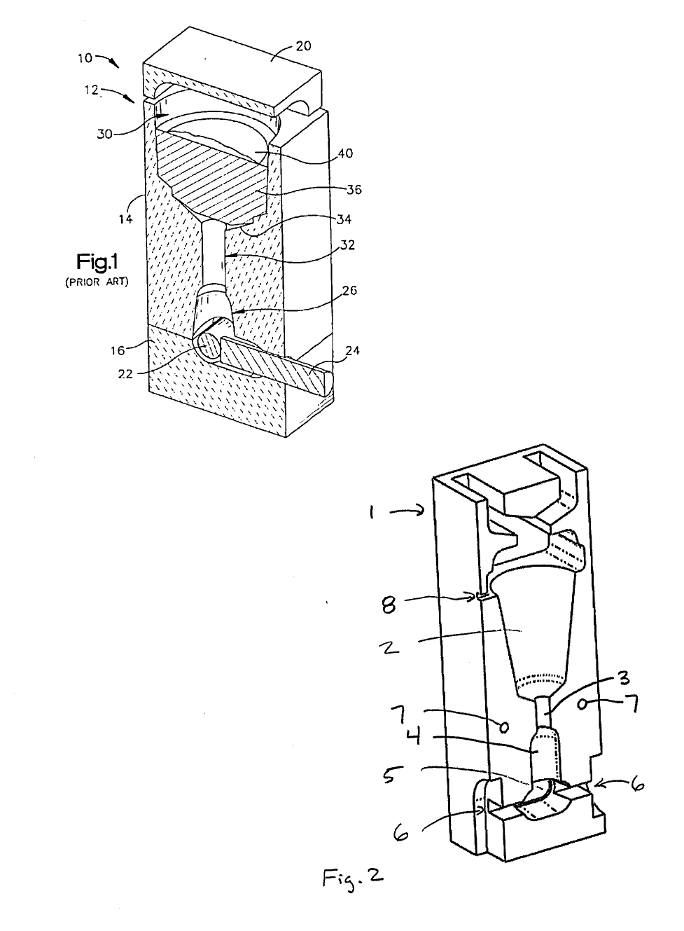

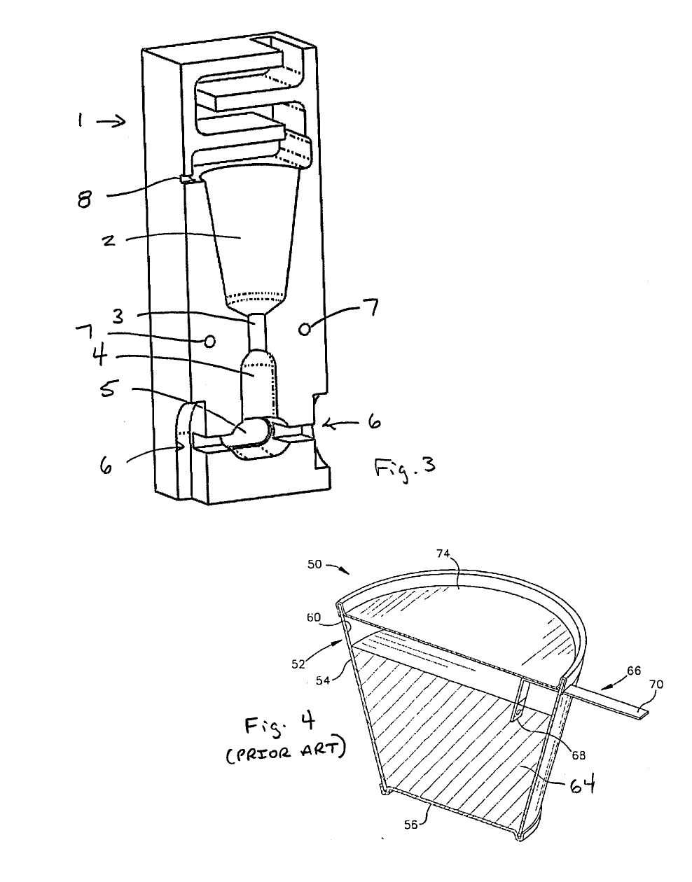

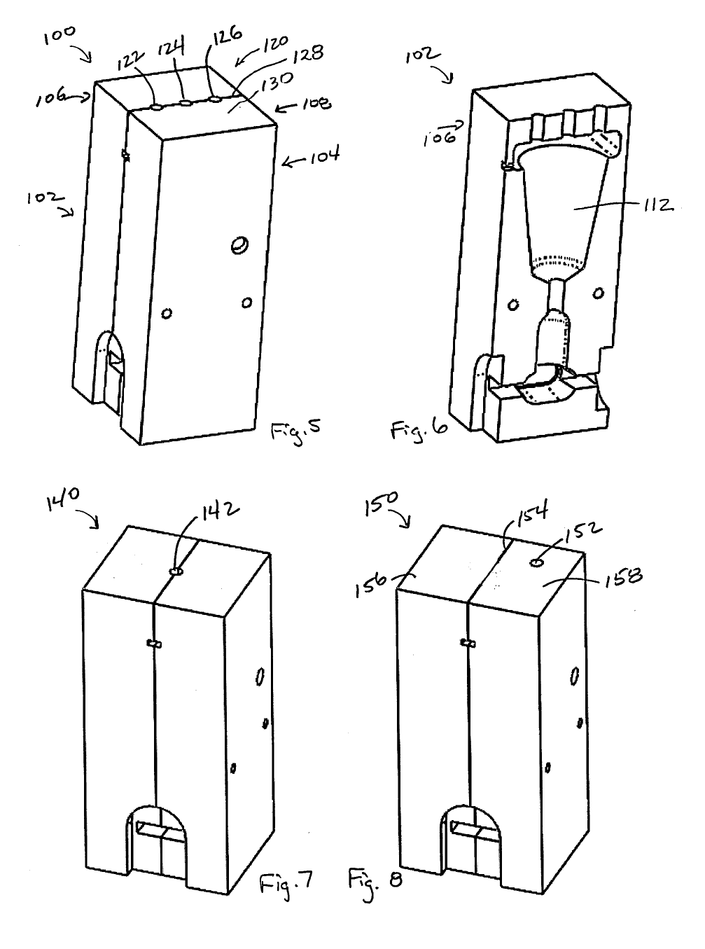

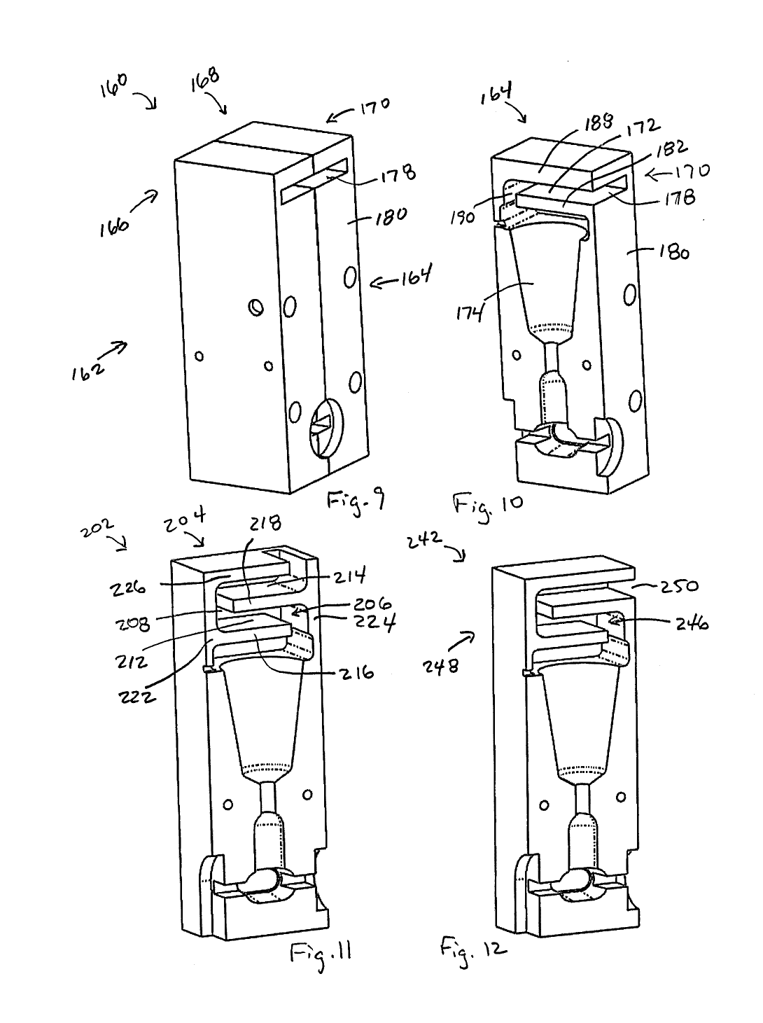

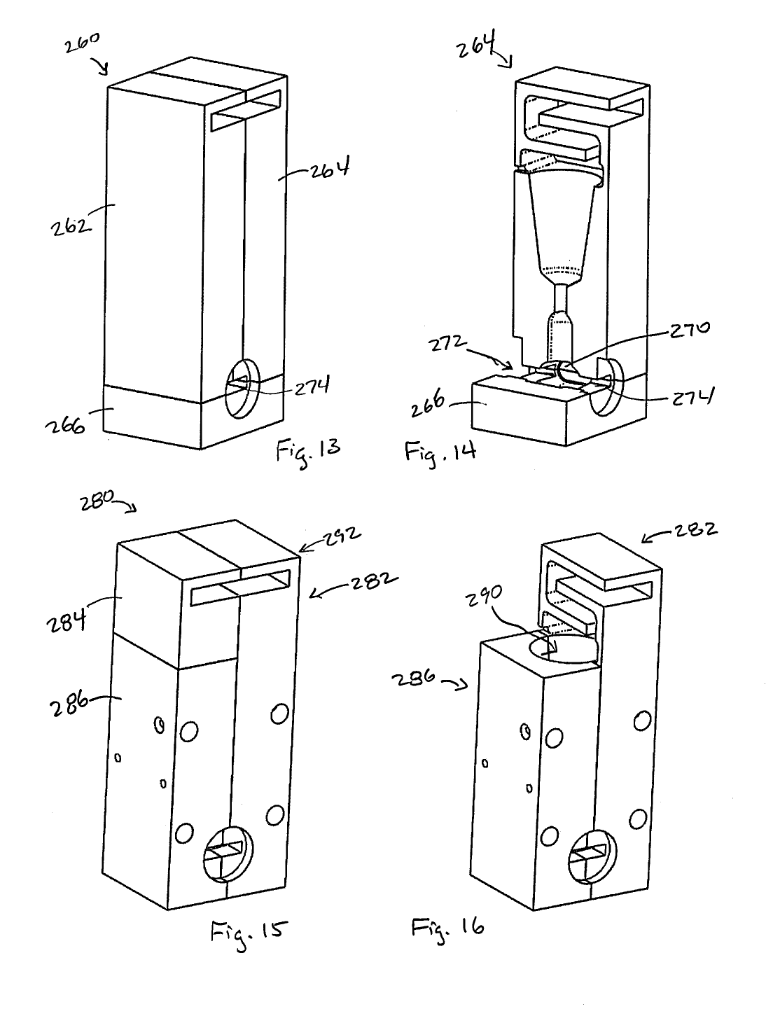

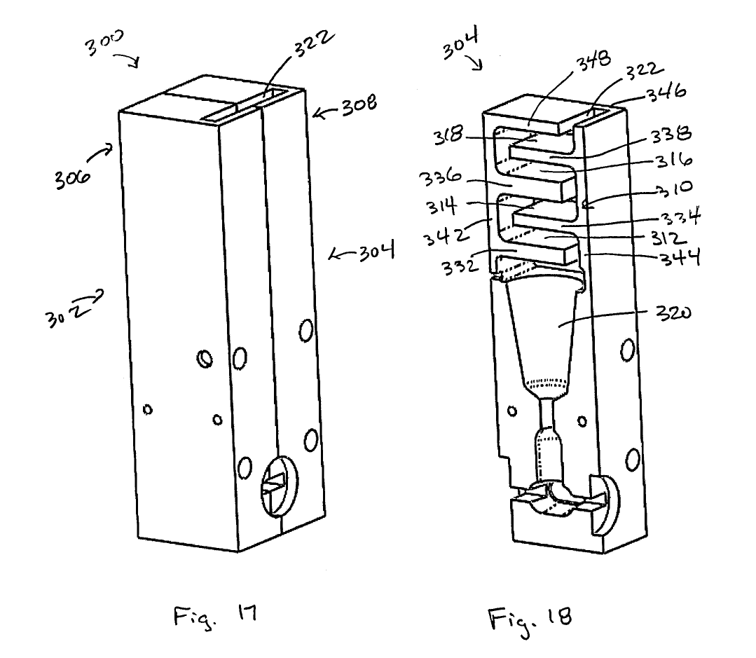

While the mold improvements described herein may be used with ERICO's CADWELD PLUS product line, the integrated mold cover may also be used with ERICO's traditional CADWELD product line as well. The CADWELD product line utilizes loose exothermic mixtures, powders that are a combination of a reductant metal and usually a transition metal oxide, as described above with regard to FIG. 1. Use of powdered weld-metal-producing material requires slightly different profiles for both the crucible (reaction chamber) and the baffle cover sections of the mold than depicted in FIGS. 2 and 3.

Though graphite molds are typically used for exothermic welding, other mold materials could be used as well. Besides graphite, a wide variety of ceramic materials could be used for the molds. Another alternative is metal, such as coated steel.

As an alternative to the mold sections with the cover portion being integrally formed as a single piece of material, the cover portions and the rest of the mold sections may be separate pieces that are permanently joined together. Such permanent joining or attaching may be accomplished by suitable methods.

What follows now are variations and alternative versions for exothermic welding molds with integral covers. Features of the various embodiments described herein may be combined where appropriate. For example passages, holes, and openings of various embodiments may be combined with the various types of mold section configurations (vertical split and/or horizontal split) described herein. As another example, use of an additional filter insert may be combinable with any of the variety of cover configurations described herein as having passages.

FIGS. 5 and 6 show a mold 100 that has a pair of mold sections 102 and 104. The mold sections 102 and 104 are vertically-split mold sections, with complementary shapes fit together. The mold sections 102 and 104 have respective integral cover portions 106 and 108 and respective crucible portions (reaction chambers), such as the crucible portion (reaction chamber) 112. The mold sections 102 and 104 are each formed as part of a continuous monolithic single piece of material, such as graphite, using a suitable process, such as machining.

The cover portions 106 and 108 together constitute a cover 120 that extends fully over a reaction crucible of the weld mold 100. Three vent holes 122, 124, and 126 are openings to allow escape of pressurized gases formed by the reaction in the reaction crucible 112. The vent holes 122-126 are along the line of split 128 between the mold sections 102 and 104. The holes 122-126 are therefore defined in part by each of the mold sections 102 and 104, with first parts of the holes 122-126 defined by the mold section 102, and second parts of the holes 122-126 defined by the mold section 104. The vent hole 124 is located at substantially the center of a top surface 130 of the mold 100, with the holes 122 and 126 offset from the center on opposite sides of the center hole 124.

Other features of the mold 100, such as the reaction crucible 118, the tap hole, the weld chamber (weld cavity), the conductor openings, the alignment dowel holes, and the igniter slot, are similar to those in other embodiments described herein. Further explanation concerning these features is omitted, both for this embodiment and for the further embodiment described below.

With regard to the conductor openings, many of the embodiments described herein have two conductor openings in a line, for receiving two objects, such as metal bars or cables, to be welded together. Other conductor opening configurations are possible, for instance three conductor openings in a T shape.

FIG. 7 shows a variant, a mold 140 with a single vent hole or opening 142 located at a center of a top surface of the mold 140. FIG. 8 shows a mold 150 with a single vent hole or opening 152 that is offset from the center of the top surface, and away from the split line 154 between mold sections 156 and 158. The single vent hole alternatively could be located on a side surface of the mold.

FIGS. 9 and 10 show a mold 160 having a pair of vertically-split mold sections 162 and 164. A cover 166 is made up by respective integrally-formed cover parts 168 and 170 of the mold sections 162 and 164. The cover 166 defines a passage 172 that directs gasses from a reaction chamber 174 to an opening 178 in a side surface 180 of the mold 160. The passage 172 extends across the mold 160, with a ledge or baffle 182 separating most of the passage 172 from the reaction chamber 174. The ledge 182 may be substantially parallel to a top part 188 of the cover 166, providing the passage 172 with a substantially-constant cross-sectional area. Pressurized gases produced in the reaction chamber 174 enter the passage 172 at an inlet 190 on one side of the mold 160, near an igniter slot through which the igniter of the crucible assembly 50 (FIG. 4) passes through. The pressurized gasses travel between the ledge 182 and the top part 188, and exit through the side opening 178. This type of configuration is referred to herein as a baffled cover, in that the ledge 182 and the top part 188 act as baffles, directing and/or obstructing flow of pressurized gases produced by the reaction in the reaction chamber 178 of the mold 160. Many of the embodiments described below are also baffled covers, with top surfaces and/or ledges directing and/or obstructing flow. Some of the embodiments described below employ more intricate series of baffles than those of the mold 160.

FIG. 11 shows a single-piece mold section 202 that has an integral cover portion 204 that has a serpentine passage 206. The term “serpentine passage” is used herein to refer to a passage that changes direction with turns of 90 degrees or more. Passages having shallower turns are also possible. The serpentine passage 206 has an intermediate turn 208 of about 180 degrees, with gases entering the turn 208 from a lower passage portion 212 being turned to substantially the opposite direction to travel through an upper passage portion 214.

The lower passage portion 212 is bounded by a pair of ledges 216 and 218 that are connected to respective opposite side walls 222 and 224, as well as to the back wall, of the mold section 202. The upper passage portion 214 is bounded by the ledge 218 and a top part 226 of the cover portion 204.

The mold section 202 is combined with a corresponding shape mold section (not shown) to form a complete mold, that can be held together with suitable clamps, for example. The same is true for embodiments shown herein as only mold section, that a corresponding mold section may be combined with the illustrated mold section to produce the complete mold.

FIG. 12 shows a mold section 242 that has a serpentine passage 246 in an integral cover portion 248 that has an opening 250 that is on the side of the mold section 242. In other respects the mold section 242 is similar to the mold section 202 (FIG. 11).

FIGS. 13 and 14 show a three-piece mold 260, having a pair of vertically-split upper mold sections 262 and 264, horizontally split from a bottom mold section 266. The horizontal split comes at a weld chamber 270 and conductor openings 272 and 274 of the mold 260. The bottom mold section 266 defines the bottom of the weld chamber 270 and the conductor openings 272 and 274, and the upper mold sections 262 and 264 define the top of the weld chamber 270 and the conductor openings 272 and 274. In other characteristics the mold 260 may be similar in configuration to the mold section 242 (FIG. 12) and its complimentary mold section. The horizontal split shown in FIGS. 13 and 14 may be used as an alternative with the other embodiments described herein.

FIGS. 15 and 16 show a different three-piece mold 280, one having a mold section 282 that forms half of the mold 280. The mold section 282 is vertically split from a pair of mold sections 284 and 286. The mold sections 284 and 286 are stacked one on top of the other to together form a complimentary shape to the mold section 282. The horizontal split between the mold sections 284 and 286 is located at the top of the reaction crucible 290. The upper mold section 284 has ledges and a serpentine passage shape that compliments the configuration of a cover portion 292 that is part of the mold section 282. The upper mold section 284 and the cover portion 292 together constitute a baffled cover that is similar in shape to that of the mold section 242 (FIG. 12) and its complimentary mold section. The upper mold section 284 may be connected to the lower mold section 286 by a hinge (not shown), or may be held in place by other means, such as a clamp. Except for the horizontal split between the mold sections 284 and 286, the mold 280 may have characteristics that are the same as a mold produced from the mold section 242 (FIG. 12) and its complimentary mold section.

FIGS. 17 and 18 show a mold 300 that is made up of a pair of vertically-split mold sections 302 and 304. The mold sections 302 and 304 have respective cover portions 306 and 308 with more intricate baffled serpentine passages than other embodiments described above. The mold section 304 has a passage 310 that has four passage portions 312, 314, 316, and 318, between a reaction chamber 320 and an opening 322 for venting gases from the mold 300. The volume between the reaction chamber 320 and the opening 322 is broken up by a series of ledges 332, 334, 336, and 338. The ledges 332 and 336 emerge from a first side wall 342, and the ledges 334 and 338 emerge from a second side wall 344, which is opposite the first side wall 342. The ledges 332-338 are also in direct contact with a back wall 346 of the mold section 304. The ledges 332-338 thus interdigitate, and they act as baffles, along with a top part 348, that define the portions 312-318 of the passage 310.

The baffles (ledges) in the various embodiments described herein aid in allowing the pressurized gas passing through it to expand and be reduced in velocity. The portions of the passages function as a series of expansion chambers to facilitate this process. The expansion, direction change, and large surface area of the integral baffle covers described herein allows the gases to slow and cool before being exhausted through the opening(s) of the cover. The exhaust of molten metal splatter and flames may be eliminated, and the amount of smoke exhausted may be greatly reduced, since particulate matter is accumulated on the inner surfaces of the baffled cover.

The desirable amount of baffling depends upon the size of the reaction (the amount of exothermic weld material used), as well as other possible factors. For small reactions, it may be sufficient to have a cover with one or more vent holes without baffling, or even no cover venting at all. For larger reactions the volume of gases generated is greater, and some baffling is desirable, with more intricate baffling (a longer gas passage, with more expansion chambers) being more desirable the larger the reaction is.

As noted above, molds with integral baffled covers may be utilized with loose particulate weld-metal-producing exothermic weld material, ignited with starting powder. Such ignition may be accomplished by placing a small amount of starting material on each of the horizontal plates or ledges. The ignition of the starting material on the uppermost plate or ledge will cause a chain reaction igniting the starting material on each successively lower plate or ledge. This proceeds until the reaction reaches the starting material placed on the loose weld material in the reaction chamber. Ignition of this starting material initiates the reaction in the main weld material, and the reaction proceeds normally, as described above. Use of starting material on baffles to initiate a reaction is described further in U.S. Pat. 4,881,677, the description and figures of which are incorporated herein by reference.

FIGS. 19 and 20 show a mold section 404 that includes a filter 410 in a passage 412 between a reaction chamber 414 and an exit opening 416 wherein gases are expelled from the mold section 404. The filter 410 is placed in a filter space 420 that is configured for receiving the filter 410. The filter 410 extends into the passage 412 of the mold section 404, as well as the passage of the corresponding mold section (not shown) that combines with the mold section 404 to constitute a mold. The filter 410 may be used to reduce the amount of smoke, fumes, and other by-products in exhaust gases that are produced in the reaction chamber 414.

Suitable materials for the filter 410 include such materials as vitreous carbons, graphite materials, silicon carbide materials, zirconium oxide fabric, and ceramic coated metal fabrics. Ceramic filters should be placed at a distance from the reaction material to avoid fusion of the filter surface. In certain applications metal wool or mesh of carbon steel or other metals may be utilized. Such other metals may include stainless steel, non-ferrous alloys such as super alloys, or refractory metals such as molybdenum, tungsten, etc. Further details on suitable filter materials and configurations may be found in U.S. Pat. No. 4,889,324, the description and figures of which are incorporated herein by reference.

The combination of the filter with the integral vented cover allows the benefits of both filters and an integral cover to be realized. A separate filter assembly is not required, and the placement of the filter may be optional, allowing an end user to employ a filter only in certain situations, for example only when working in confined spaces.

The filter may be in any of a variety of shapes. Filters may be combinable with any of the suitable embodiments disclosed herein, for example in any of the baffled embodiments described above. FIG. 21 shows one such alternative, a mold section 444 having a filter 450 in a serpentine passage 456. This is but one alternative of a large variety of filtered baffled vented integral covers.

As another alternative, a filter may be placed in a baffled passage or other flow-turning passage of a separate module that is coupled to a mold. Separate baffle modules are described in U.S. Pat. No. 4,881,677, and separate filter modules are described in U.S. Pat. No. 4,889,324. Such a separate module, with both baffles (or flow turning without baffles) and a filter, could be coupled to a mold using suitable threaded fasteners or clamps, for example.

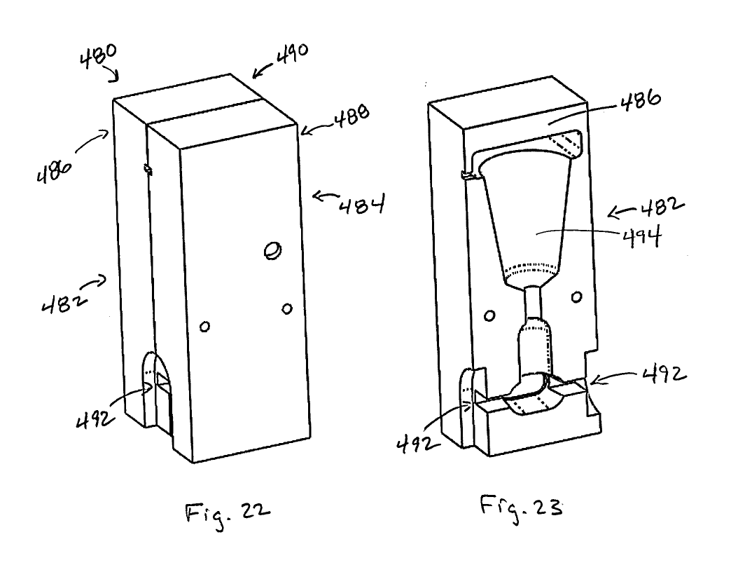

FIGS. 22 and 23 show a mold 480 that has a pair of mold sections 482 and 484 that have respective integral cover portions 486 and 488 that provide no vent openings in a cover 490 that is the combination of the cover portions 486 and 488. Any pressurized gases produced by the reaction are vented out of conductor openings 492. The mold 480 has the advantage of not expelling heated exhaust gases through the top of the mold 480, or the upper part of side surfaces of the mold 480. The integral unvented cover 490 provides good structural integrity for containing the gasses produced in a reaction chamber 494 of the mold 480. The mold 480 may be suitable for small reactions that do not produce much in the way of pressurized gases.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An exothermal weld mold comprising:
a mold section having a crucible portion that defines part of a reaction crucible for receiving an exothermic weld metal material;
wherein the mold section includes an integral-formed cover portion, formed with the rest of the mold section as a single piece of material, that covers the reaction crucible at least in part.

2. The weld mold of claim 1, further comprising an additional mold section, wherein the mold sections together define the reaction crucible.

3. The weld mold of claim 1, further comprising an additional mold section, wherein the mold sections together define a cover that extends fully over a reaction crucible of the weld mold.

4. The weld mold of claim 3, wherein the mold sections are vertically-split mold halves that together constitute substantially all of the mold.

5. The weld mold of claim 4, wherein the mold sections also together define the reaction crucible, a weld chamber, and a tap hole that is in communication with both the reaction crucible and the weld chamber.

6. The weld mold of claim 3, wherein the cover has an opening therein for exhaust of gasses from the reaction crucible.

7. The weld mold of claim 6, wherein the opening is a top surface opening on a top surface of at least one of the mold sections that is above the reaction chamber when the mold is in use.

8. The weld mold of claim 7, wherein the top opening is defined in part by each of the mold sections.

9. The weld mold of claim 7, wherein the top opening is located substantially at a center of the top surface.

10. The weld mold of claim 7, wherein the top opening is offset from a center of the top surface.

11. The weld mold of claim 6, wherein the opening is a side surface opening on a side surface of at least one of the mold sections, wherein the side surface has a substantially vertical orientation when the mode is in use.

12. The weld mold of claim 6, wherein the opening is in communication with a passage, defined by the mold, between the opening and the reaction chamber; and

13. The weld mold of claim 12, wherein the passage includes at least one change of direction between the reaction chamber and the opening.

14. The weld mold of claim 13, wherein the passage is a serpentine passage that changes direction at least twice between the reaction chamber and the opening.

15. The weld mold of claim 14, further comprising a filter in the serpentine passage.

16. The weld mold of claim 14, wherein the serpentine passage doubles back upon itself, having a first passage portion of the passage that directs exhaust gasses from the chamber in an opposite direction from a second passage portion of the passage.

17. The weld mold of claim 16, wherein the passage is defined by baffles that are integral parts of the single pieces of material of the mold sections.

18. The weld mold of claim 16, further comprising a filter in the passage.

19. The weld mold of claim 3, further comprising a third mold section, wherein the third mold section is hingedly coupled to the additional mold section.

20. The weld mold of claim 19, wherein the additional mold section and the third mold section are horizontally split.

21. An exothermal weld mold comprising:
a mold section having a crucible portion that defines part of a reaction crucible for receiving an exothermic weld metal material;
wherein the mold section includes an integral-formed cover portion, formed with the rest of the mold section as a single piece of material; and
wherein the cover portion includes a passage therethrough to an opening for expelling gasses from a reaction crucible portion of the mold section.

22. The weld mold of claim 21, wherein the passage is a serpentine passage.

23. A method of exothermic welding comprising:
reacting weld material in a reaction crucible of a mold to produce molten weld metal; and
venting gases from the reacting weld material through an opening in the mold, wherein the opening is in a cover portion of a mold section of the mold that is formed as part of a single piece with a crucible portion of the mold that at least in part defines the reaction crucible.

24. The method of claim 23, wherein the venting includes passing the gases through a passage between the reaction crucible and the opening.

25. The method of claim 24, wherein the venting further includes passing the gases through a filter located in the passage.

26. The method of claim 23, wherein the venting includes passing the gases through a baffled passage between the reaction crucible and the opening.

27. The method of claim 23, wherein the venting includes passing the gases through a serpentine passage between the reaction crucible and the opening.
